(19) United States
(12) Patent Application Publication
(10) Pub. No.: US 2016/0005128 A1
(43) Pub. Date: Jan. 7, 2016

(54) SYSTEMS AND METHODS OF APPLYING HIGH PERFORMANCE COMPUTATIONAL TECHNIQUES TO ANALYSIS AND EXECUTION OF FINANCIAL STRATEGIES

(71) Applicant: Elsen, Inc., Cambridge, MA (US)

(72) Inventors: Justin L. White, Arlington, VA (US); Zachary R. Sheffer, Boston, MA (US)

(73) Assignee: ELSEN, INC., Cambridge, MA (US)

(21) Appl. No.: 14/791,004

(22) Filed: Jul. 2, 2015

Related U.S. Application Data
(60) Provisional application No. 62/020,717, filed on Jul. 3, 2014.

(51) Int. Cl. G06Q 40/06; G06Q 40/04

(52) U.S. Cl. CPC G06Q 40/06; G06Q 40/04

(57) ABSTRACT

Systems and method of the present disclosure are directed to a strategy assessment tool that facilitates developing a financial strategy, testing the financial strategy on historical data, and applying the strategy in real time to activate trades. The strategy assessment tool can retrieve, obtain, or otherwise identify financial data related financial instruments. The tool can store the financial data in a database or data structure such that the tool can efficient analyze the data using one or more financial strategies running on multiple threads of a GPU.

A portion of the disclosure of this patent document contains material which is subject to copyright protection. The copyright owner has no objection to the facsimile reproduction by anyone of the patent document or the patent disclosure, as it appears in the file or records of the Patent and Trademark Office, but otherwise reserves all copyright rights whatsoever.

### CROSS REFERENCE TO RELATED APPLICATIONS

The present applications claims the benefit of priority under 35 U.S.C. §119 to U.S. Provisional Patent Application No. 62/020,717, filed Jul. 3, 2014, and is hereby incorporated by reference herein in its entirety.

### FIELD OF THE DISCLOSURE

This disclosure generally relates to systems and methods for applying high performance computational techniques to analyze and execute financial strategies. In particular, this disclosure relates to systems and methods that facilitate creating strategies, testing strategies using historical data, and executing strategies against real time data feeds.

### BACKGROUND OF THE DISCLOSURE

Entities may use various strategies to facilitate buying and selling stocks in a stock market. Entities may apply their strategy to financial data to determine when to buy or sell a stock. Due to the complexity of financial strategies and large amounts of data, it may be challenging for an entity to create an effective financial strategy.

### BRIEF SUMMARY OF THE DISCLOSURE

The present solution provides a new tool for applying high performance computational techniques to analyze and execute financial strategies to facilitate making a financial decision (e.g., buy, sell, hold, short, trade, hedge, etc.) on a financial instrument or asset (e.g., tradable asset, stocks, mutual funds, bonds, commodities, derivatives, securities, bills, commercial paper, futures, bond futures, options, equity futures, currency futures, exchange-traded derivatives, etc.) in a financial market (e.g., stock market, bond market, financial exchange, etc.). By applying these techniques, entities (e.g., a user of the tool, company, broker, agent, etc.) may create a strategy, test the strategy using historical data, and execute the strategy against real-time data feeds.

In some embodiments, the tool includes a Software as a Service (“SaaS”) platform configured to execute multiple threads on one or more graphical processing units (“GPU”). The tool can write real time and historical data using the same database scheme or data structure scheme, and then pass the real time or historical data to multiple threads on a GPU (e.g., tens, hundreds or thousands of threads). Using multiple threads on a GPU and the same database scheme for real time and historical data, the tool can quickly analyze an entire financial instrument exchange (e.g., stock exchange), and perform daily, hourly or minute-by-minute analyses on stocks. By analyzing all financial instruments in an exchange, the tool removes biases that may result from analyzing only selected subsets of stocks. Further, by using the same strategy analysis engine (or configuration thereof) to apply strategies to historical financial data and real time financial data, the tool can efficiently and quickly switch from a back test (e.g., applying a strategy on historical financial data to determine performance of the strategy) to a live execution of the strategy (e.g., applying the strategy to make a financial decision associated with a financial instrument, such as a buying, selling, shoring, or holding a financial instrument).

In some embodiments, the tool provides a user interface (e.g., graphical user interface or other interface) configured to allow a user to interact with the tool. For example, the graphical user interface may provide simplistic, but open ended point and click interface to allow users to combine a number of technical indicators against a number of data sets. The tool can facilitate generating permutations of these strategies to allow for ease of discovery of optimal indicator values and date ranges. For example, an indicator may refer to a pattern that automates the process of indicating when to buy or sell a financial instrument. The tool can automatically generate, provide, transmit or otherwise convey, via the user interface, notifications via a network to a computing device (e.g., electronic mail, push/pull notification, SMS text message, instant message, data feed, etc.) when strategies have completed processing or require further action. A user can then execute one or more strategies (e.g., via one-click execution) when strategies have been autonomously applied against live data streams. In some embodiments, a user can share strategies via the tool using by embedding data about the strategy in an electronic communication or providing a link to the strategy data via a third-party website (e.g., a social networking platform).

In some embodiments, the tool can be configured to perform automatic data ingestion and preparation. For example, the tool can use HTTP to fetch and receive data from one or more data providers via a network. The data providers can include third party providers of financial data, news data, current event data, weather data, or any other data that can facilitate creating or applying a strategy for buying and selling financial instruments. The tool can store this data in a general database that is accessible to the tool. This general database can be source agnostic, and may apply internal tags to track or identify the source of the data. For example, middleware can be applied to incoming data to tag the data before the data is stored in the database. A meta value can be calculated for the data, which can refer to a calculation of aggregated daily values, for example. By performing substantial indexing on the data, physical clustering of hardware components or using optimized hardware configurations, the tool can provide rapid access to arbitrary slices of data across the entire available data range.

In some embodiments, the tool includes a computational engine that applies a strategy to the data to determine how the strategy would perform or make a buy/sell decision (or any financial decision such as shorting a stock, holding a stock). The computational engine can employ one processing thread per strategy run and use the same core code (e.g., executable instructions) to apply the strategy to historical data and real time (or live) data streams. In one embodiment, the computation engine can be configured to connect each thread with the database. For example, the computation engine can be in a loop state while listening or waiting for a new a strategy. When the computation engine receives a new strategy to analyze or apply to data, the computation engine parses or otherwise processes the strategy and creates a new strategy object. The computation engine can then perform dynamic query generation to generate queries that will be used to fetch, obtain or otherwise identify data. The computation engine, upon obtaining the data, can create a data object that includes the fetched or received data. The computation engine, using this data, can perform indicator calculations on a processor. In some embodiments, the computation engine performs the data calculations on a central processing unit (“CPU”) and a GPU. In some embodiments, the computation engine initiates the thread on the GPU. The indicators can include or be used as a type of filter that allows a user to screen or search for events (in historical data or real time data). In some embodiments, the indicators can include industry standard technical indicators. In some embodiments, indicators can include algorithms or statistics used to measure, determine or identify events, current conditions, historical conditions, or forecast financial or economic trends. For example, an event may include a simple moving average line crossing an exponential moving average line. The indicators can be combined in both buy and sell groups wherein the indicators in the group triggers a “BUY” or “SELL” decision or trade. Triggering the buying or selling of a financial instrument can be referred to as the activation of the buy or sell rule associated with the indicator.

The computation engine can perform the activation filtering, ordering and initial evaluation on a CPU and a GPU. If activations were calculated in parallel (e.g., via multiple processing threads that are overlapping such that more than one thread is running at a time), they can be ordered by timestamp such that the final evaluation is done properly. Initial evaluation can include populating activation (trade) objects with data from a period during which the activation occurred. During the final activation evaluation, trade limits and other user selected meta filters can be applied to the data. The accepted activations are inserted into the primary database and notifications can be sent to the user associated with the strategy.

In some embodiments, the computation engine can use a Message Passing Interface (“MPI”) to scale processing to multiple available worker threads in the environment, including, for example, across networks and servers. Each thread may access a local GPU to accelerate determining or computing indicators using data sets. Further, the hardware can be configured to reduce latency between database and worker threads.

At least one aspect is directed to a method of analyzing a financial strategy via a tool. The tool can receive presets for a financial strategy and data filters to determine a company mix. The tool can use a CPU to determine the company mix. The tool can include one or more processors receiving financial data, indexing the data and clustering the data in one or more databases. The tool can establish financial indicators such as buy/sell indicators and perform an initial assessment, full assessment or back test based on the indicators. The tool can run the indicators on the financial data using multiple GPU threads, where each thread corresponds to one company. For example, a single GPU thread can apply one or more indicators to financial data for a single company in order to make a buy/sell decision based on the results of the indicators.

At least one aspect of the present disclosure is directed to a method of parallel processing of financial exchange data. The method can be performed by a tool that includes a data ingest module, computation engine and an interface. The data ingest module receives, via the interface data records for financial instruments from a data provider. Each of the data records includes a company identifier, a time stamp, a price, and a volume. The data ingest module stores the received data records in an indexed data structure. The computation engine identifies an indicator of a strategy set via a user interface of the tool. The computation engine applies via a first thread of a processor of the tool, the indicator to a first portion of the indexed data structure corresponding to a first company to generate a first assessment. The computation engine applies via a second thread of a processor of the tool, the indicator to a second portion of the indexed data structure corresponding to a second company to generate a second assessment. The first thread can overlap with the second thread. The computation engine executes based on the first assessment and the second assessment, the strategy on a real-time feed of data records for financial instruments.

In some embodiments, the data ingest module is configured with middleware executing on the processor to perform meta value determinations on the data records. The data ingest module indexes the data records based on the determined meta value. The data ingest module stores the indexed data records in the indexed data structure based on the determined meta value. In some embodiments, the tool generates a query responsive to a filter set via the interface of the tool. The tool can transmit via an HTTP fetch, the query to the data provider. The tool can receive a response to the transmitted query. The tool can maintain a materialized view with the response in the indexed data structure. In some embodiments, the data ingest module maintains historical data and the real time feed of data in the indexed data structure using a same database scheme.

In some embodiments, the tool establishes a plurality of indicators of the strategy. The plurality of indicators of the strategy include at least two of a moving average cross, a relative strength index, and a Bollinger band. The tool applies via the first thread of the processor of the tool, the plurality of indicators to the first portion of the indexed data structure corresponding to the first company to generate the first assessment. The tool applies via the second thread of the processor of the tool, the plurality of indicators to the second portion of the indexed data structure corresponding to the second company to generate the second assessment.

In some embodiments, the tool applies a moving average indicator to smooth data to form a trend pattern to predict or estimate a price direction for a first time interval. The tool can remove, responsive to receiving real time feed data, a first value in the trend pattern and adding a second value to the trend pattern. In some embodiments, the tool applies, via a plurality of threads of a graphical processing unit, the strategy on data records for a plurality of companies. The computation engine applies the strategy for each of the plurality of companies on a separate thread of the plurality of threads.

In some embodiments, the tool applies the strategy to data records of an entire financial instrument exchange on a periodic basis. The periodic basis can include at least one of daily or hourly. In some embodiments, the tool uses a message passing interface to apply the strategy for a plurality of companies in the indexed data structure. I some embodiments, the tool receives a filter via the interface of the tool. The tool identifies a company mix based on the filter including the first company and the second company.

Another aspect is directed to a system to parallel process financial exchange data. The system can include a tool executed by a processor. The tool can include an interface, data ingest module and a computation engine executed by one or more processors of the tool. The data ingest module can be configured to receive, via the interface, data records for financial instruments from a data provider. Each of the data records includes a company identifier, a time stamp, a price, and a volume. The data ingest module can further store the received data records in an indexed data structure. The computation engine can be configured to identify an indicator of a strategy set via the interface of the tool. The computation engine can apply, via a first thread of the processor, the indicator to a first portion of the indexed data structure corresponding to a first company to generate a first assessment. The computation engine can apply, via a second thread of a processor of the tool, the indicator to a second portion of the indexed data structure corresponding to a second company to generate a second assessment. The first thread can overlap with the second thread. The tool can execute, based on the first assessment and the second assessment, the strategy on a real-time feed of data records for financial instruments.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein.

FIG. 2 is an illustrative embodiment of a system comprising a strategy assessment tool.

FIG. 3 is an illustrative flow diagram of an embodiment of obtaining and preparing data via the strategy assessment tool.

FIG. 4 is an illustrative block diagram of an embodiment of a data layout used by the strategy assessment tool.

FIG. 5 is an illustrative flow diagram of an embodiment of processing a strategy via the strategy assessment tool.

FIG. 6 is an illustrative flow diagram of an embodiment of processing a strategy via the strategy assessment tool.

FIG. 7 is an illustrative flow diagram depicting a method of using the strategy assessment tool.

FIGS. 8-14 are illustrations of embodiments of systems and methods of assessing a strategy.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods for a strategy assessment tool.

A. Computing and Network Environment

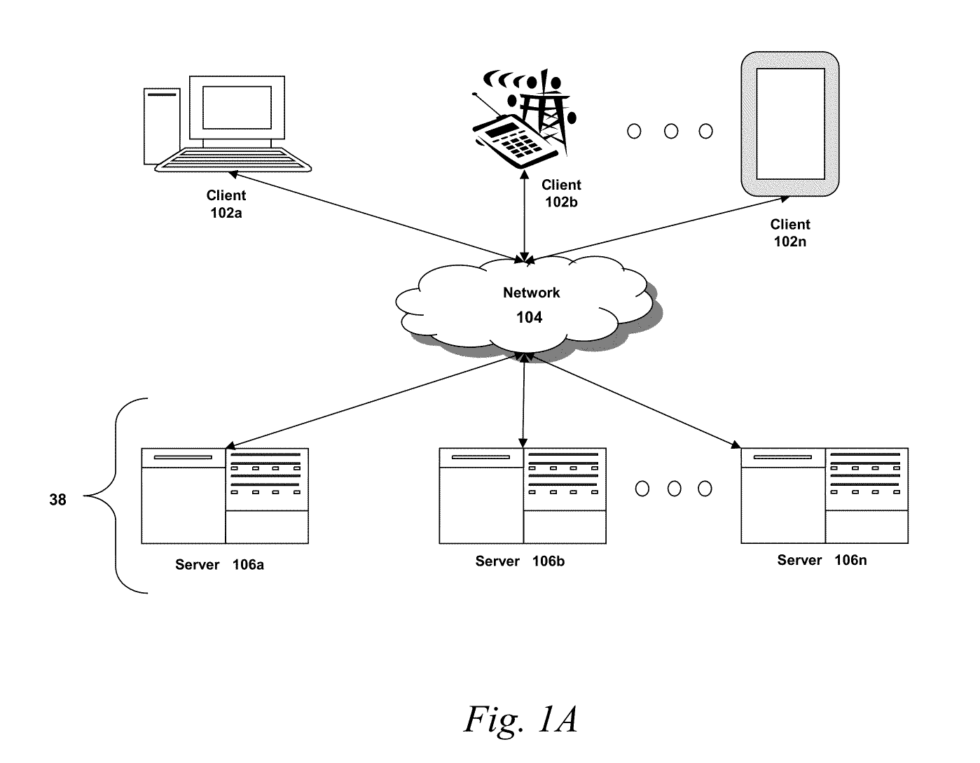

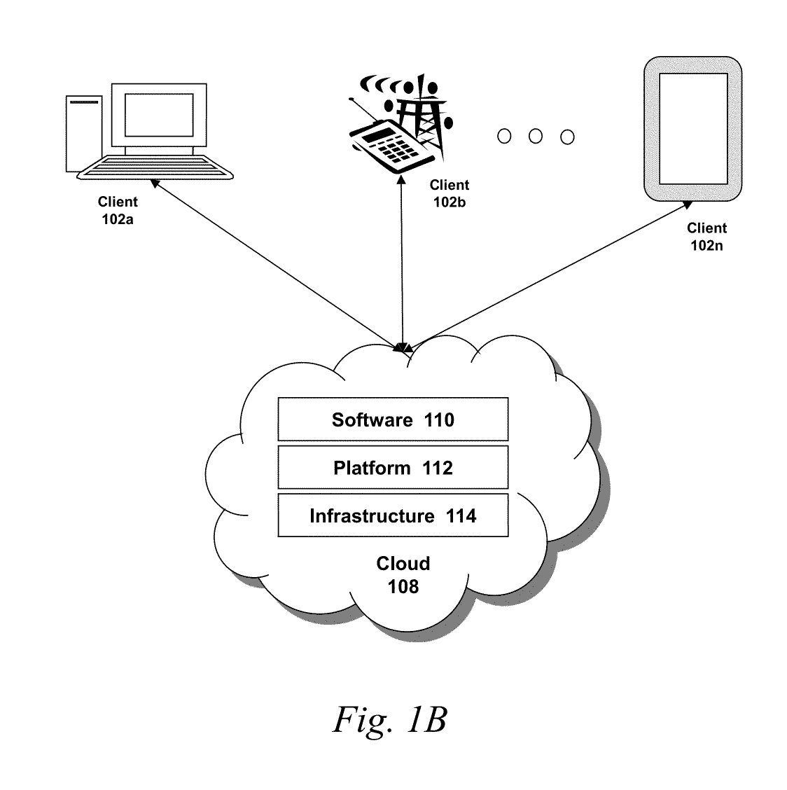

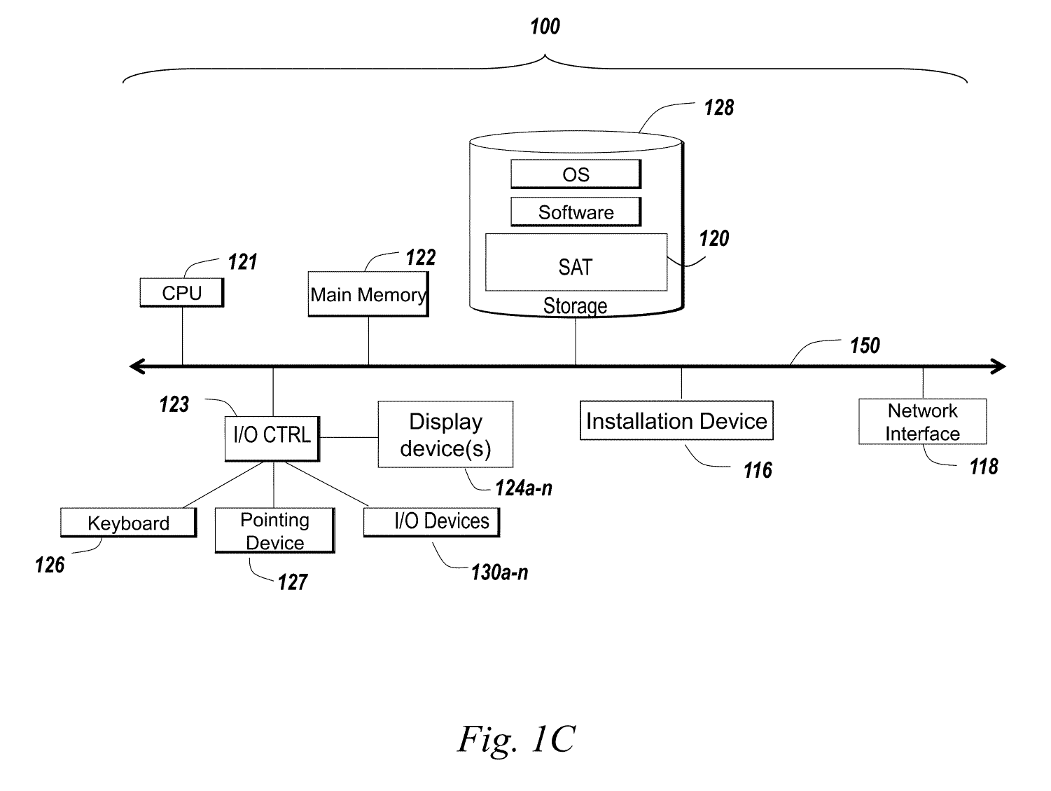

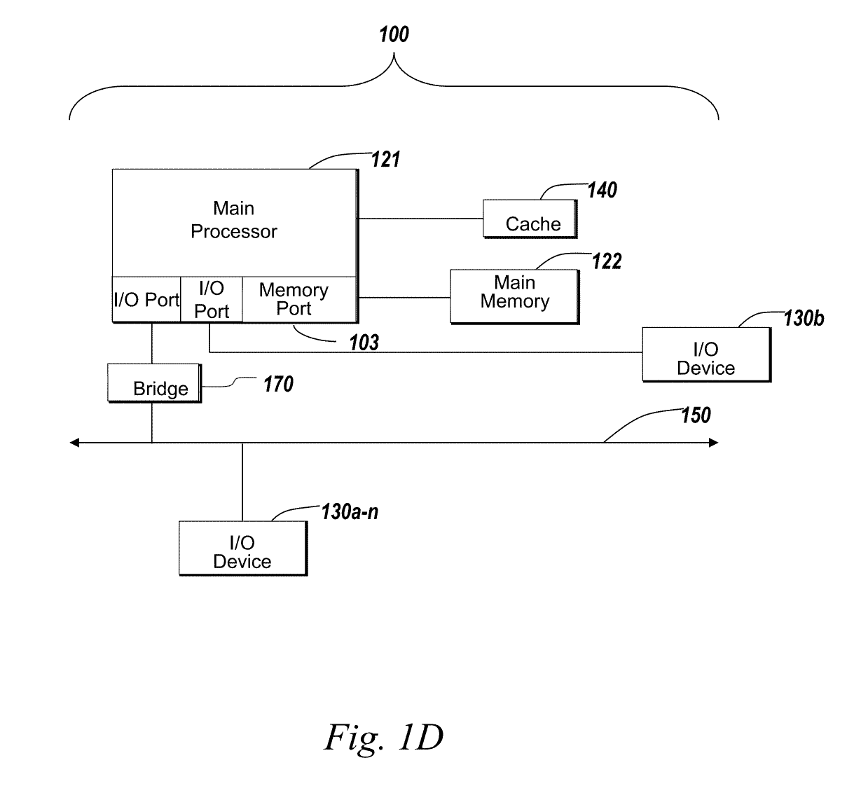

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS can include infrastructure and services (e.g., EG-32) provided by OVH HOSTING of Montreal, Quebec, Canada, AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of a strategy assessment tool 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. Multiple threads may execute in an overlapping manner such that more than one thread is executing at the same time, but may not start and stop at the same time. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the candidate assessment tool. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 are monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

B. Strategy Assessment Tool

Systems and method of the present solution are directed to a strategy assessment tool that facilitates developing a financial strategy, testing the financial strategy on historical data, and applying the strategy in real time to activate trades. The strategy assessment tool can retrieve, obtain, or otherwise identify financial data related financial instruments. The tool can store the financial data in a database or data structure such that the tool can efficiently analyze the data using one or more financial strategies.

In an illustrative embodiment, the tool analyzes all stocks in a stock exchange. By analyzing all stocks, the tool can minimize biases that may result from analyzing a subset of selected stocks. The tool is configured to use database indexing and clustering techniques, as well as multithreaded processing on CPUs and GPUs. For example, the tool obtains real time and historical data feeds, digests the data by tagging it and performing meta calculations, and stores the data in one or more databases using indexing and clustering schemes. By using the same indexing and clustering scheme for historical and live data, the tool can quickly and efficiency switch between back tests and live tests. Once the data is stored and indexed, the tool can calculate one or more indicators that, when met, trigger a buy/sell decision (or activation). To quickly and efficiently determine indicators in real time (or during back tests), the tool can efficiently fetch appropriate data slices from the indexed and clustered data structures in the database, and then execute the indicator determinations on a multitude of GPU threads. For example, the tool can run one thread per company to determine the indicators for that company and make a financial decision (e.g., buy/sell decision) based on the results of the indicator calculations. Thus, if there are thousands of companies in the stock exchange, the tool can run thousands of threads on the GPU to make buy/sell decisions for each company in parallel.

The tool can perform this analysis on historical data to help create or test a strategy. The tool can also perform this analysis in real time on live data in order to execute trades in a financial exchange in real time.

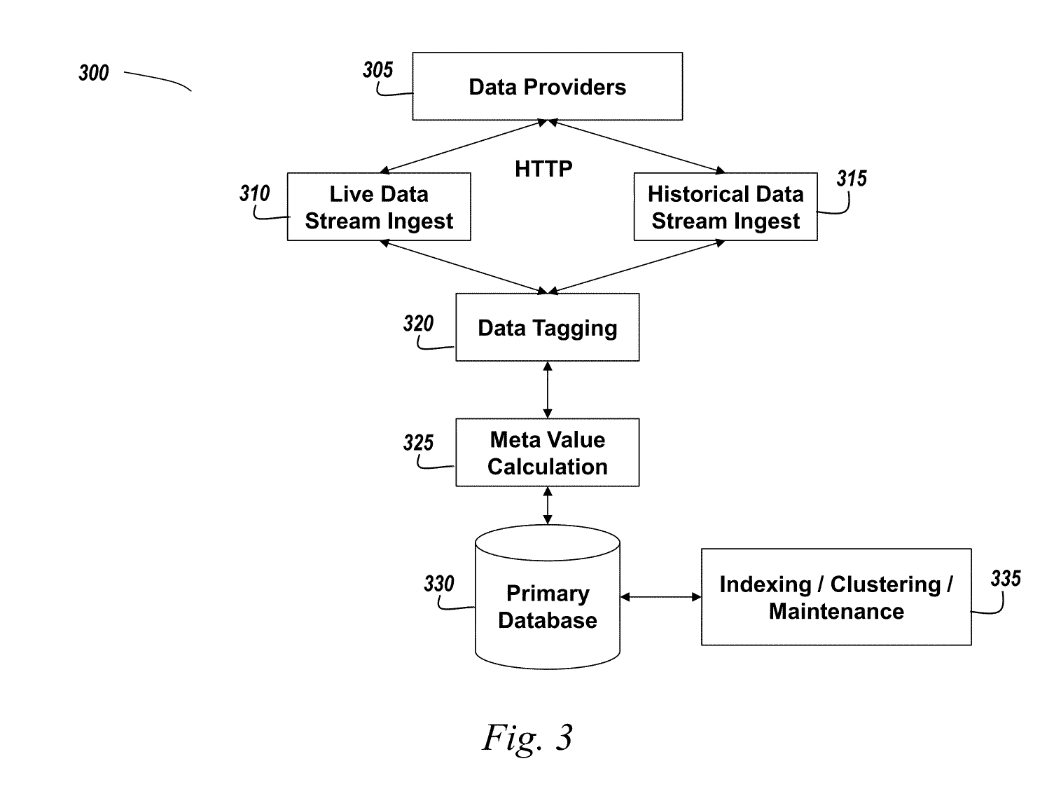

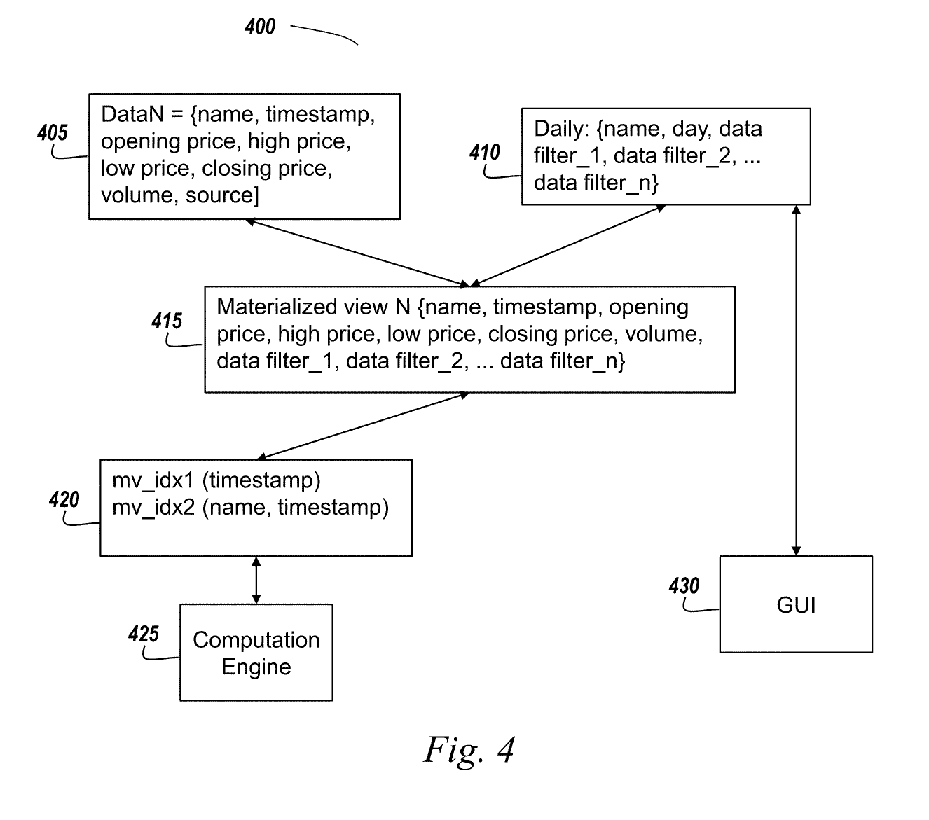

FIG. 3 provides an overview of an illustrative flow diagram of an embodiment of obtaining and preparing data via the strategy assessment tool. Once the data is prepared (e.g., indexed and clustered in a database), the tool can quickly calculate indicators that are used to make financial decisions (e.g., buy/sell, short, or hold decisions). At step 305, the strategy assessment tool (“tool”) obtains data from one or more data providers via a network communication protocol. For example, the tool can use an HTTP fetch to obtain data from data providers. At steps 310 and 315, the tool can begin preparing the data by performing a live data stream ingest 310 and a historical data stream ingest 315. Upon receiving the data 310 and 315, the tool can tag the data at block 320. The tool can tag the data with information such as a data source, time stamp, meta data, etc. At step 325, the tool performs meta value calculations, such as calculating an aggregated value or other statistical information (e.g., aggregated volume of trades over a time period). At step 330, the tool can save the data in a primary database. At step 335, the tool can perform indexing and clustering to organize the data such that the tool can quickly and efficiently retrieve data and calculate indicators. For example, the routines run at step 335 can maintain the materialized views 415 illustrated in FIG. 4. While the tool may receive, store, and index the data using a CPU, the tool can calculate indicators using a GPU. For example, the tool can use one GPU thread per company to calculate indicators and make a buy/sell decision as GPUs are capable of running thousands of threads.

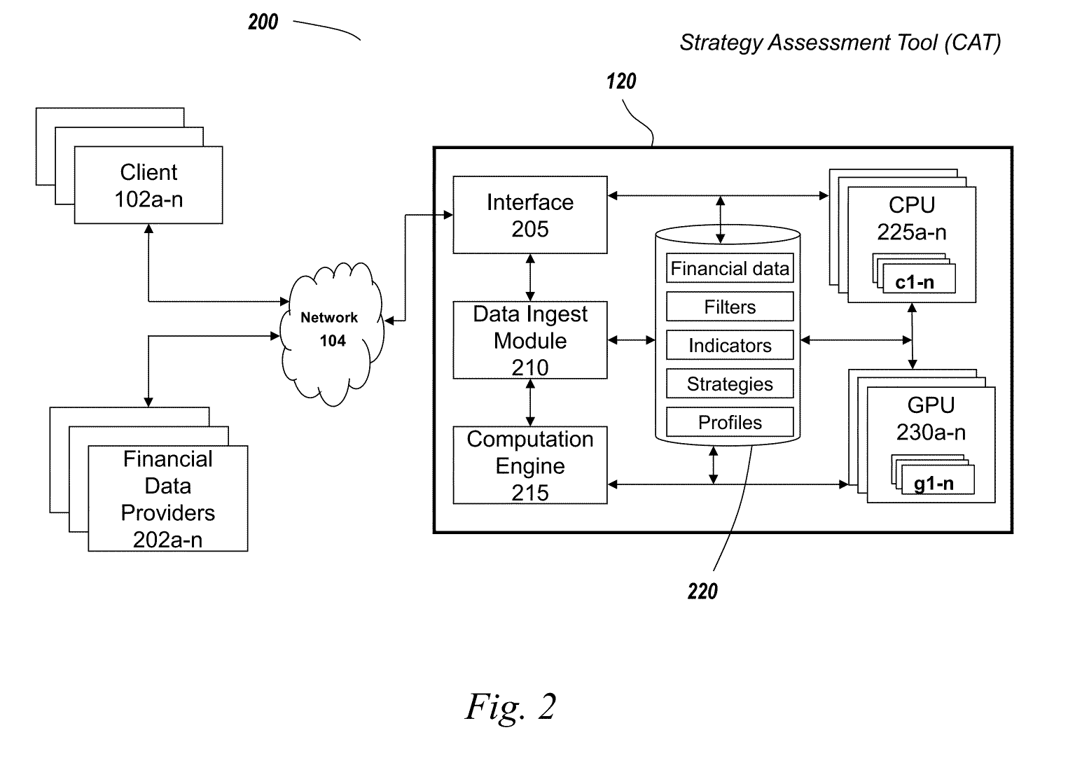

Referring to FIG. 2, an embodiment of a system comprising a strategy assessment tool 120 is depicted. In brief overview, the tool 120 includes an interface 205 that can receive user input and data input and output data. In some embodiments, the tool 120 includes a data ingest module 210 that can tag received data, apply middleware to the data, and otherwise pre-process obtained financial data. In some embodiments, the tool 120 includes a computation engine 215 that can apply strategies to financial data. The computation engine 215 can use one processing thread per strategy run and use the same core code to process historical and live data streams. In some embodiments, the tool 120 includes one or more central processing units (“CPUs”) 225a-n and one or more graphical processing units (“GPUs”) 230a-n. In some embodiments, the CPUs 225a-n and GPUs 230a-n are each capable of running multiple threads. In some embodiments, the GPUs 230a-n are capable of running significantly more threads than the CPUs 225a-n (e.g., hundreds or thousands of threads versus tens of threads). In some embodiments, the tool 120 includes a database 220 or data structure stored in one or more memory elements. The database 220 can store financial data, data filters, indicators or algorithms, strategies, user profiles, or any other information that facilitates assessing a strategy.

The interface 205, data ingest module 210, computation engine 215, CPU 225a-n, GPU 230a-n, and database 220, can comprise of the components in FIGS. 1A-1D. The components of the strategy assessment tool, including, e.g., 205, 210, 215, 220, 225a-n, and 230a-n may comprise an application, program, library, script, service, process, task or any other type and form of executable instructions executing on a client 102, server 106 or cloud 108. The components 205, 210, 215, 220, 225a-n, and 230a-n may interface with a plurality of modules, components, or systems of the tool 120 or external to the tool via network 104 or another way.

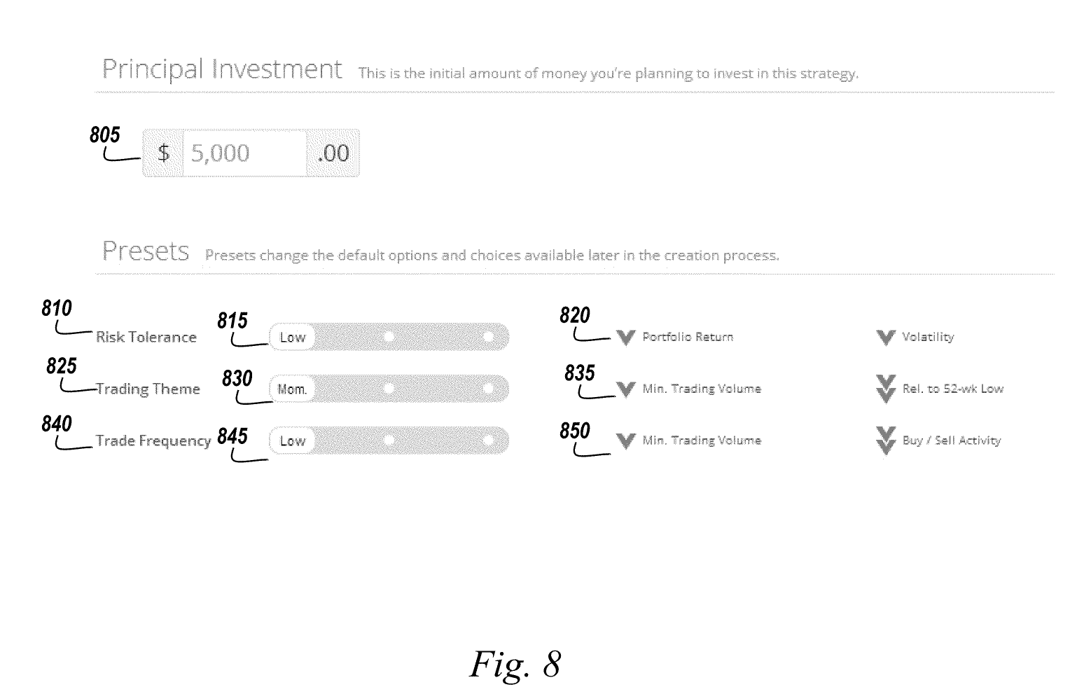

In further detail, some embodiments of the candidate assessment tool 120 include an interface 205 designed and constructed to receive user input and data input, and output data. The user interface may present and provide access to the functionality, operations and services of the strategy assessment tool 120. To implement the functionality of the tool, the interface 205 may include any number of user interface components generally referred to as widgets. A widget may comprise any one or more elements of a user interface which may be actionable or changeable by the user and/or which may convey information or content. For example, a widget may be an input text box, dropdown menu, button, file selection, etc. Interface widgets may comprise any type and form of executable instructions that may be executable in one or more environments. Each widget may be designed and constructed to execute or operate in association with an application and/or within a web-page displayed by a browser. One or more widgets may operate together to form any element of the interface, such as a dashboard. The user interface may include any embodiments of the user interfaces shown or described in FIGS. 8-14 or any portions thereof or functionality provided by such user interfaces.

In some embodiments, the interface 205 can be configured to communicate with clients 102a-n and financial data providers 202a-n via network 104. Clients 102a-n may include any computing device such as a mobile telecommunications device, smartphone, tablet, notebook computer, e-book, desktop computer, smart watch, wearable computing devices, etc. Financial data providers 202a-n may include any entity, database, computing device or source that can provide information that facilitates analyzing or executing a financial strategy. In some embodiments, financial data providers 202a-n may include news websites, a news aggregator, a financial instrument exchange, a stock exchange, blogs, a weather database, an historical event database, etc. The interface 205 can obtain the data from financial data providers 202a-n in various formats or using various techniques. In some embodiments, the tool 120 may parse or evaluate data of financial providers 202a-n to obtain information, such as evaluating data on a financial provider 202a-n web site to determine financial information (e.g., evaluate news articles for keywords, semantics, topical information to determine financial trends, health of company, financial events, etc.). In some embodiments, the tool 120 may receive a data feed from a financial provider 202a-n, such as a real time data feed, periodic data feed, batch data upload, web feed, rich site summary (“RSS”) data feed, etc. In some embodiments, the tool 120 can utilize an HTTP fetch technique to obtain data from financial data providers 202a-n. In some embodiments, the tool 120 receives data in one or more sources and can store the data in a different format or structure that facilitates analyzing the data.

In some embodiments, the tool 120 includes a data ingest module 120 designed and constructed to obtain data and preprocess the data or facilitate storing the data in a format that facilitates efficient processing of the data. For example, the data ingest module 210 can obtain data from the database 220 in certain slices that allow the tool to perform efficient processing on the data. In some embodiments, the data ingest module 210 can, via the interface 205, use an HTTP fetch to obtain data from financial providers 202a-n. The data ingest module 210 can then store this data in database 220 in a source agnostic manner such that regardless of the format of the received data, the data stored in the database 220 is in a standard format. The data ingest module 220 can further tag the data with various information to track the source of information. For example, the data ingest module 220 can tag the data with source information, time stamps, topical information, category information, type (e.g., type of source such as news site, blog, stock exchange, etc.). Financial data may include the name of a company, a time stamp associated with the data (e.g., when recorded, obtained, determined, sent by financial provider, received by tool 120), opening price for stock, high price of stock during a time period (e.g., a day, week, month, quarter, year, 48 hours, 72 hours, or other time period), low price during a time period, closing price, volume of trades during a time period, source of the financial data.

In some embodiments, the data ingest module 210 comprises middleware that processes incoming data before the data is stored in database 220. Middleware can include a software layer that lies between an operating system and applications of the tool 120 that supports the applications of the tool 120. The data ingest module 210 can perform one or more meta value calculations using the data and store these values in the database 220. Meta value calculation may include, for example, aggregated daily values for stock prices, volume, gains, losses, statistical values, etc.

Further, the data ingest module 210 may perform indexing and clustering on the data to allow rapid access to arbitrary slices of data across the available data range. For example, a database index (e.g., bitmap index, dense index, sparse index, reverse index, etc.) may include a data structure (e.g., balanced trees, B+ trees, hashes, etc.) that improves the speed of data retrieval operations on a database table. An index can include a copy of select columns of data from a table that can be searched very efficiently that also includes a low level disk block address or direct link to the complete row of data it was copied from. Indexes can facilitate quickly locating data without having to search every row in a database table every time a database table is accessed. Indexes can be created using one or more columns of a database table, providing the basis for both rapid random lookups and efficient access of ordered records. The data ingest module 210 may employ one or more non-clustered or clustered index. In a non-clustered index, the data can be present in an arbitrary order, but the logical ordering may be specified by the index. The data rows may be spread throughout the table regardless of the value of the indexed column or expression. The non-clustered index tree can include the index keys in a sorted order, with the leaf level of the index containing the pointer to the record (page and the row number in the data page in page-organized engines; row offset in file-organized engines). In a clustered index, the clustering can modify the data block in an order to match the index, resulting in the row data being stored in order. By ordering the physical data rows in accordance with the index blocks that point to them, clustered indices can increase overall speed of retrieval.

In some embodiments, the data ingest module 210 can join multiple databases and multiple tables to form a cluster. For example, the records for the tables sharing the value of a cluster key can be stored together in the same or nearby data blocks. This may improve the joins of these tables on the cluster key, since the matching records are stored together and less I/O is used to locate them. The cluster configuration may define the data layout in the tables that are parts of the cluster. A cluster can be keyed with a B-Tree index or a hash table. The data block where the table record is stored can defined by the value of the cluster key.

In some embodiments, the tool 215 includes a computation engine 215 designed and constructed to process financial data. The computation engine 215 can run one or more threads on one or more CPU 2250a-n or GPU 230a-n. The computation engine 215 can utilize a message passing interface (“MPI”) to perform processes on multiple processors, cores or threads. For example, the MPI can be implemented using one or more of C, C++, assembly language, Perl, Python, R, Ruby, Java, CL, etc. For example, the computational engine can employ one processing thread per strategy run and use the same core code (e.g., executable instructions) to apply the strategy to historical data and real time (or live) data streams. In one embodiment, the computation engine can be configured to connect each thread with the database.

While waiting or listening for data, the computation engine 215 can enter or maintain a loop state. When the computation engine 215 receives new data, the computation engine 215 evaluates, parses or otherwise processes the data using one or more filters, strategies or indicators. The computation engine can then perform dynamic query generation to generate queries that will be used to fetch, obtain or otherwise identify data. For example, the computation engine 215 can apply a data filter using dynamically created queries to the data to create a data object, such as a materialized view data object. The computation engine, upon obtaining the data, can create a data object that includes the fetched or received data.

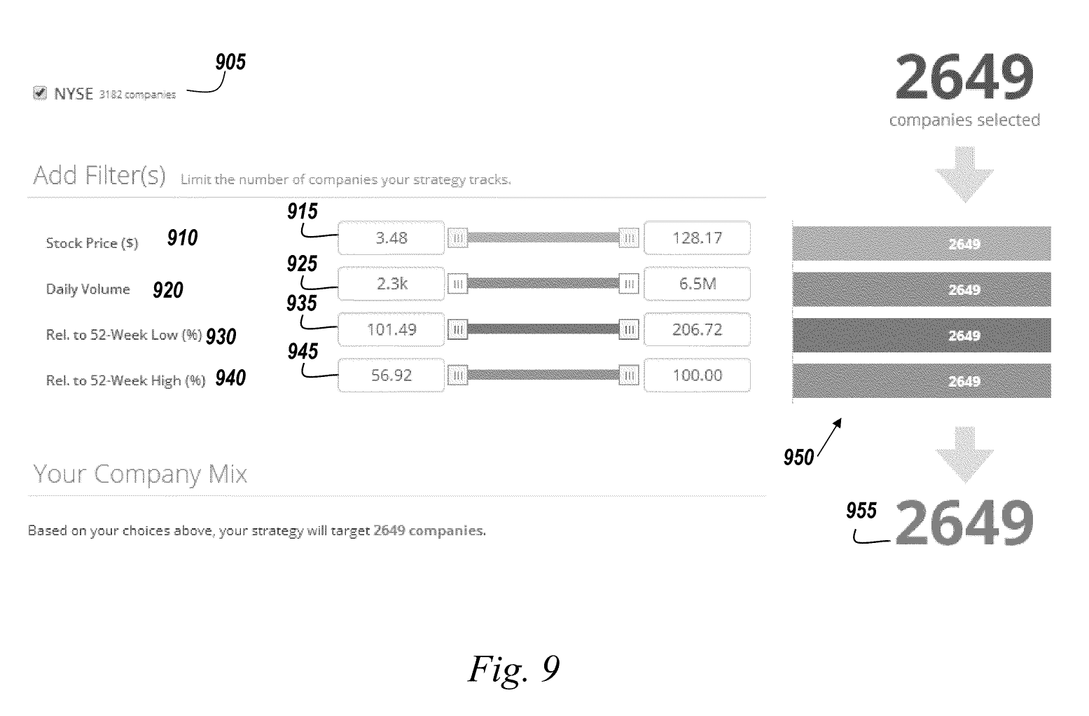

FIG. 4 depicts an example process and data layout 400 of the computation engine 215 and tool 120, in accordance with an embodiment. In some embodiments, the data ingest module 210 and/or the computation engine 215 performs one or functions of the data layout process 400. In some embodiments, at block 405, the tool obtains a data structure “DataN” that includes, for each company, a name, timestamp, opening price for a time period (e.g., a day, week, month, etc.), high price for a time period, low price for a time period, closing price for a time period, volume for a time period, and source of the information. The time period may be consistent for all metrics (e.g., a day or week). At block 410, the tool obtains data filters to be applied to the data and dynamically generates queries for the data filters. The data filters can be based on stock price, daily volume, relative to 52-week low, or relative to 52 week high as illustrated in the GUIs shown in FIG. 9 (referenced by block 430).

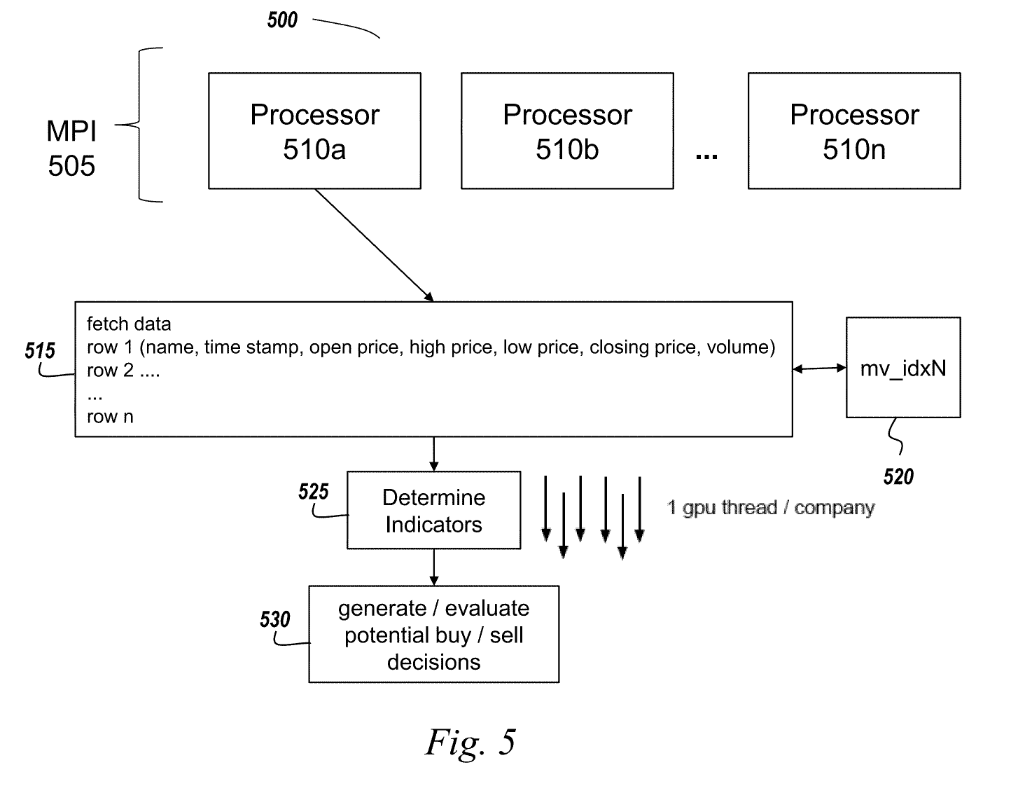

The tool 120 can dynamically generate queries based on the data filters and store the results of the query in a materialized view object in block 415. For example, a dynamically generated query may include a query for all companies with a stock price between 4 and 128 and a daily volume between 2,300 and 6,400,000. The materialized view 415 (or snapshot) may be a local copy of data, or may be a subset of the rows and/or columns of a table or join result, or may be a summary based on aggregations of a table's data. The query result can be cached as a table that may be updated from the original base tables from time to time, thus enabling more efficient access. As the materialized view is manifested as a real table, columns can be indexed, enabling speedups in query time, as shown in block 420. These indexes shown in block 420 can be used by the computation engine in block 425 to calculate indicators and make buy/sell decisions. Further, and in some embodiments, routines run at block 335 can maintain the materialized views 415. At block 515, in FIG. 5, dynamically generated queries can query the materialized views 415 to obtain the sought after data.

For each index mv_idx1 (timestamp) or mv_idx2 (name, timestamp), etc, shown in block 420, the computation engine 215 can perform data analysis on a per data point basis for each company. The computation engine 215, using this data, can perform indicator calculations on a processor. Thus, when the computation engine 215 performs an indicator calculation or determination, the computation engine 215 can utilize the materialized view index (block 420) to speed up query time. The computation engine 215 can perform the indicator determinations on a GPU 230. For example, the computation engine 215 can use one GPU thread per company to calculate the indicators. Indicator determinations performed in parallel (e.g., via multiple processing threads), can be ordered by timestamp such that the final evaluation can be ordered in chronological order or other logical order.

The indicators can include or be used as a type of filter that allows a user to screen or search for events (in historical data or real time data). In some embodiments, the indicators can include industry standard technical indicators. In some embodiments, indicators can include algorithms or statistics used to measure, determine or identify events, current conditions, historical conditions, or forecast financial or economic trends. For example, an event may include a simple moving average line crossing an exponential moving average line. The indicators can be combined in both buy and sell groups wherein the indicators in the group triggers a “BUY” or “SELL” decision or trade. Triggering the buying or selling of a financial instrument can be referred to as the activation of the buy or sell rule associated with the indicator.

FIG. 5 depicts an example data process 500 of the computation engine 215 and tool 120, in accordance with an embodiment. The data process 500 may include the tool 120 using an MPI interface 505 to manage multiple processors 510a-n. The tool 120 (e.g., data ingest module 210 or computation engine 215) can use the multiple processors 510a-n and MPI 505 to perform the initial data filtering to create the materialized view indexes (e.g., as shown in blocks 405-420 of FIG. 4). In data process 500, the tool 120 can fetch 515 the data indexed by materialized view indexes 520 (e.g., created in block 420). For example, at step 515, the tool, using the dynamically generated queries, can query the data in materialized view 415 of FIG. 4 to obtain, retrieve, receive, request or identify the relevant data chunk. Each row in this data structure can include financial data for a company, such as the name of the company, timestamp, open price, high price, low price, closing price, and volume. One or more fields of the data may be based on a predetermined time period, such as a day, week, month, quarter, etc. The data may include meta data that indicates a source of the data, category of company, data format information, etc.

In some implementations, the tool can use caching operations at the operating system level to facilitate storing the results of the queries at step 515. For example, the tool may use page cache (or disk cache) to transparently cache pages kept in main memory by the operating system for quicker access. In some implementations, the page cache may be implemented in kernels with the paging memory management, which may be transparent to applications executing on the tool. The amount of page cache may vary based on memory utilization by the tool or other applications executing on one or more servers of the tool. The tool may use various types of caching including, e.g., page level caching, output caching, page fragment caching, partial-page output caching, programmatic caching, data caching, application caching, or any other caching operations that can facilitate assessing a financial strategy by the tool 120.

At block 525, the tool 120 can determine indicators. The tool 120 can use a separate GPU thread for each company. For example, each thread may have a series of data (515) that is used to determine an indicator or perform an indicator calculation. For example, if there are three indicators or conditions that, if met, trigger a buy or sell decision, then the single GPU thread can calculate the three indicators to make a buy or sell decision (block 530) for that company. In some embodiments, the series of data may include multiple rows of data, such as rows 1 through row N in block 515. In some embodiments, the rows of data needed to perform an indicator calculation can be based on the time period over which the indicators are being calculated (e.g., a start and stop time period for a back test). In some embodiments, when performing live, real time indicator calculations, the tool calculates the indicators on a minute-by-minute basis as the tool obtains data feeds using one GPU thread for each company. In some embodiments, the tool 120 may use multiple GPU threads for a company by associating a time stamp for each thread and combining the results of the threads to make a financial decision (e.g., buy/sell decision).

At block 530, the tool 120 can generate a financial decision, or evaluate a potential buy/sell decision. The tool 120 creates the financial decision based on the indicator calculations or indicator determinations generated at block 525. The tool 120 can store the buy/sell decisions in a database, forward buy/sell notifications to a user of the tool 120 via a network, or execute the buy/sell trade in a stock exchange.

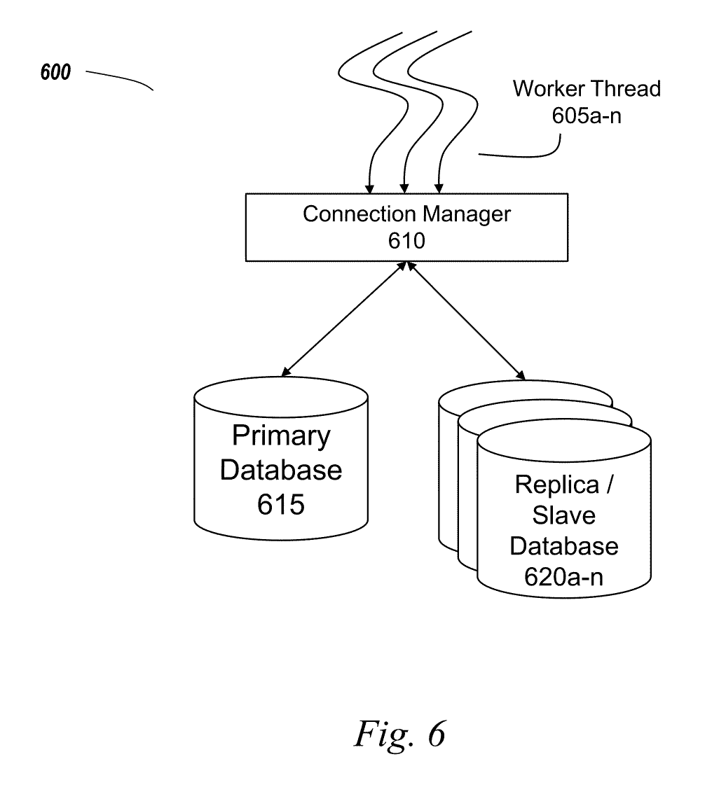

FIG. 6 is an illustrative flow diagram 600 of an embodiment of processing a strategy via the strategy assessment tool. The tool 120 can initiate multiple worker threads 605a-n for strategy runs. For example, the tool 120 can use separate threads 605a-n for each strategy run. The tool 120 can use a connection manager 610 (e.g., a software based connection manager) to connect the threads 605a-n to the databases 615 and 620a-n. The databases 605a-n and 620a-n may include historical and live data that has been indexed and clustered by the tool 120.

The connection manager 610 may facilitate worker threads accessing data from databases 615 and 620a-n where the databases are remotely stored and accessed via a network. To facilitate rapid access of data, the connection manager 610 may establish files needed to create a connection to a remote network associated with one of the databases. As the tool 120 may run tens, hundreds, or thousands of threads, the connection manager 610 may facilitate the rapid and efficient establishment of a connection to a database 615 or 620. In some embodiments, the connection manager 610 may establish a persistent connection such that each thread 605a-n need note initiate and establish a separate connection. For example, the connection manager 610 may function as a gateway between the threads 605a-n and the databases 615 and 620a-n. That is, the connection manager 610 may establish the connection between the databases 615 and 620 such that the servers containing the databases 615 and 620a-n communicate directly with the connection manager 610. Thereafter, when a worker thread 605a-n initiates a request for data, the connection manager 610 can parse the request and then forward the request for data to the appropriate network device or database 615.

In some embodiments, the connection manager 610 can perform load balancing functions. For example, as thousands of threads 605a-n access data in a database, the performance of the database or server associated with the database may become a bottleneck. Thus, the connection manager 610 may manage the connections by balancing them over several replica/slave databases 620a-n. The connection manager 610 may use any load balancing scheme to distribute workloads across multiple databases, such as round-robin DNS (e.g., threads sent to different databases), scheduling algorithms, or persistence (e.g., a single thread maintains a persistent connection with a database until the thread is complete).

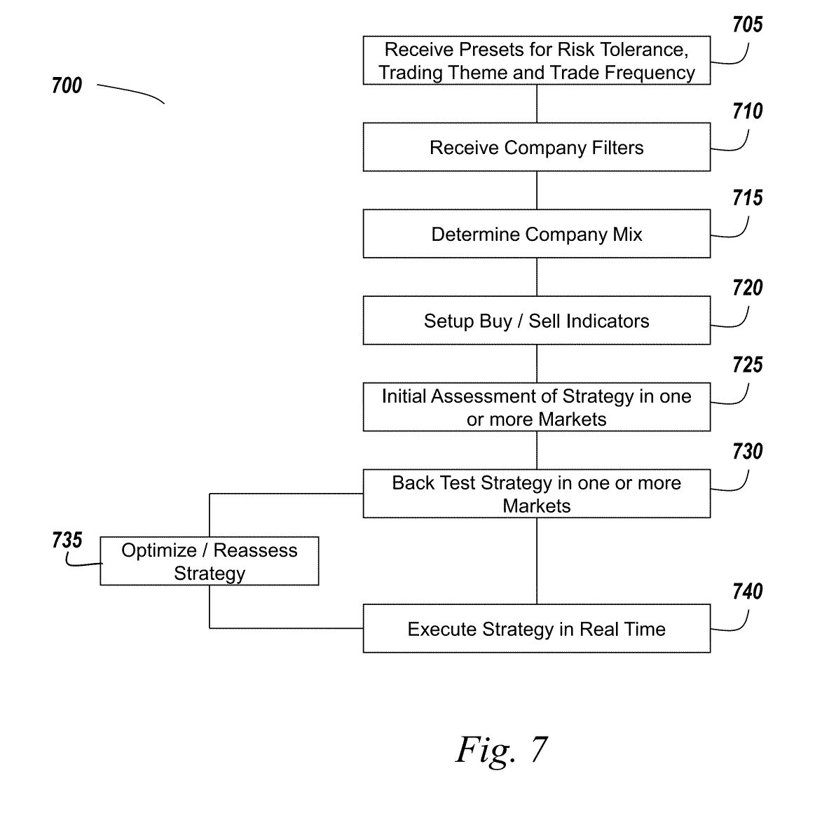

FIG. 7 is an illustrative flow diagram depicting a method of using the strategy assessment tool, and FIGS. 8-14 are illustrations of embodiments of graphical user interfaces of systems and methods of assessing a strategy. In brief overview, and in some embodiments, at step 705 the tool receives presets or initial inputs that are used to create or generate a financial strategy. At step 710, the tool receives company filters for the strategy. At step 715, the tool determines a set of companies that satisfy the filters, to be used in the strategy. At step 720, the tool receives buy/sell indicators and values associated with same to be used in the strategy. At step 725, the tool performs an initial assessment of the strategy in one or more markets. The markets may be automatically determined by the tool, fall into a market category, or may be set by a user of the tool. At step 730, the tool performs a back test on the strategy in the one or more markets. At step 735, the tool may allow a user to optimize or reassess the strategy by altering, e.g., an indicator, market, presets, etc. At step 740, the tool can execute the strategy in real time.

Still referring to FIGS. 7-14, and in further detail, at step 705, the tool, via a graphical user interface, receives presets used to develop a strategy. For example, the presets may be entered via a graphical user interface shown in FIG. 8. The presents may include, e.g., principal investment (805), risk tolerance (810), trading themes (825) and trade frequency (840). FIG. 8 illustrates a slide bar GUI for inputting the presets, but other buttons, sliders, input boxes, or widgets may be used. Risk tolerance 810 may be low, may be low, medium or high, or any other value on a spectrum of low to high. The risk tolerance may be discrete values, categories, numerical or scores. In this example, a low risk tolerance refers to a conservative investor willing to accept lower returns in exchange for the safety of their investments. Medium refers to an investor believing in a balanced portfolio by spreading risks among many products and strategies. High may refer to an aggressive investor looking for fast, exceptionally high profits and willing to risk losing a lot of money. The indicators 820 associated with risk tolerance 810 may reflect the risk tolerance. For example, a high risk tolerance may indicate an increases portfolio return (e.g., 2 arrows pointing up) and increased volatility (e.g., two arrows pointing up).

Trading theme 825 may refer to companies that match a user's chosen criteria or trends such as momentum, value or quality and can be selected via GUI widget 830. Momentum trading theme refers to companies that are trending in a certain direction (e.g., earnings or price) and takes positions in the same direction. Value trading theme refers to companies that sell less than their intrinsic value, or those that the market has undervalued. Quality trading theme identifies companies with outstanding qualities such as financial strength, attractive valuation, and corporate governance. The indicators 835 may reflect the trading theme. For example, quality trading theme may refer to an increased in minimum trading volume and a moderate minimum stock price.

The trade frequency preset 840 can be used to determine how often a user is willing to make trades. Trade frequency can be set via GUI widget 845 as follows: low (e.g., 1 or 2 trades per month), medium (e.g., 1 or 2 trades per week), or high (e.g., five trades per week). The trade frequency can be set using numerical values (e.g., a user can specify the number of trades over a time period). The indicators 850 can illustrate an increased/decreased minimum trading volume and buy/sell activity based on the trade frequency.

At step 710, the tool receives company filters. The tool can receive company filters via a GUI illustrated in FIG. 9, in accordance with an embodiment. The tool can apply the filters to generate a company mix for the strategy. The tool can apply the filters using one or processors and store the results in a database or generate a data structure index representing the company mix.

The filters may include stock exchanges. For example, the tool may operate on one or more exchanges 905, and the user may select one or more exchanges for a strategy (e.g., national exchanges, public exchanges, private exchanges, international exchanges, New York Stock Exchange, NASDAQ, etc.). The tool can further receive filters, such as filters based on stock price 910, daily volume 920, percentage of current price relative to 52-week low 930, percentage of current price relative to 52-week high 940. The tool can provide, via the GUI, widgets or slider bars 915, 925, 935, and 945 to allow a user to enter filter values. For example, the slider bars can allow a user to input a low and high value for each filter. Using these filters, the tool can identify the number of companies 950 that satisfy each filter. For example, if the stock price filter 910 has bounds of 3.48 and 128.17, then the tool can identify that 2649 companies (950) out of the 3182 companies on the NYSE exchange (905) qualify. By applying all filters on the exchange, the tool can identify a total set of companies 955 for further processing, e.g., a company mix.

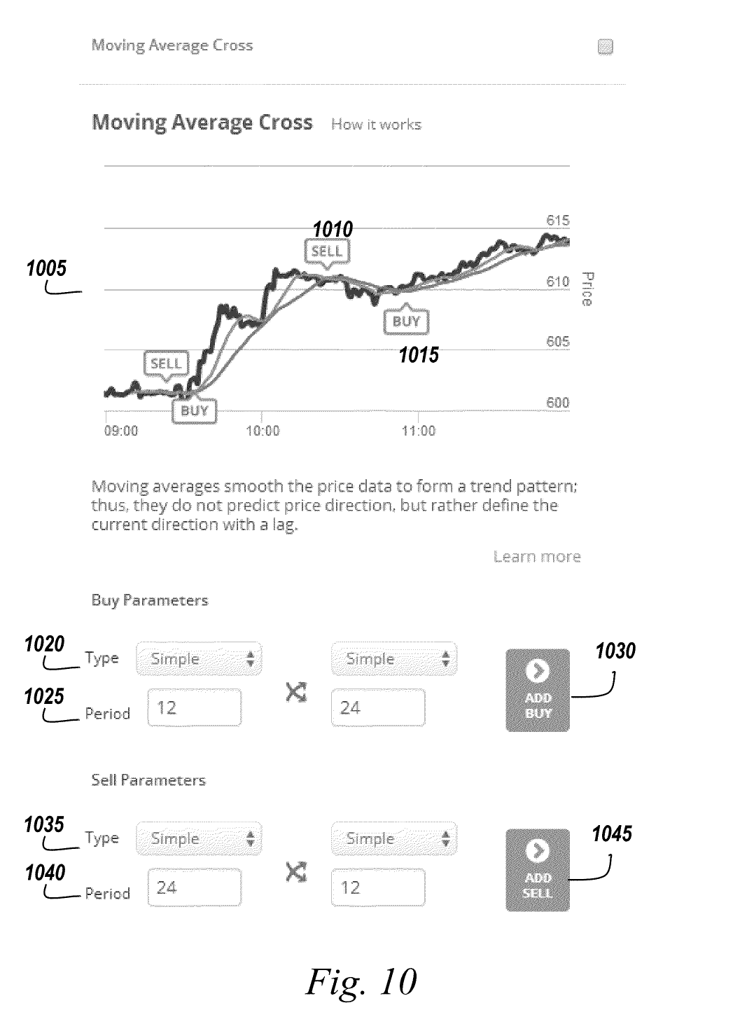

At step 720, the tool establishes financial indicators (e.g., buy/sell indicators). The buy/sell indicators can be established using a GUI, as illustrated in FIGS. 10-12. For example, the indicators may include statistical indicators such as moving average cross, relative strength index, and Bollinger bands. A user may select one or more indicator. As shown in FIG. 10, the moving average can smooth the price data to form a trend pattern to predict or estimate a current price direction, with a lag. For example, the moving average can be calculated by picking a window (e.g., 10 days), summing the stock's closing price over the last window, and dividing by the size of the window. As the tool moves through time, new prices are added to the front, while old values are dropped off the end, allowing the value to reflect the fluctuations in the stock price in a smooth and more signal-conveying way than the raw data alone. As more old data is included than new data, trends or momentum shifts may be slower to appear in the moving average. As shown in FIG. 10, the GUI may include buy parameters 1020 and 1025 and sell parameters 1035 and 1040. The buy and sell types 1020 and 1035 may include drop down menus for simple and exponential types, and input text boxes 1025 and 1040 for time periods, respectively. A user may choose to add the buy and/or sell indicator to the strategy by selecting Add Buy 1030 or Add Sell 1045. In this example, the GUI may provide an illustrative chart or graph 1005 that highlights buy 1015 or sell 1010 decisions made using the moving average indicator over a sample time period for a sample company.

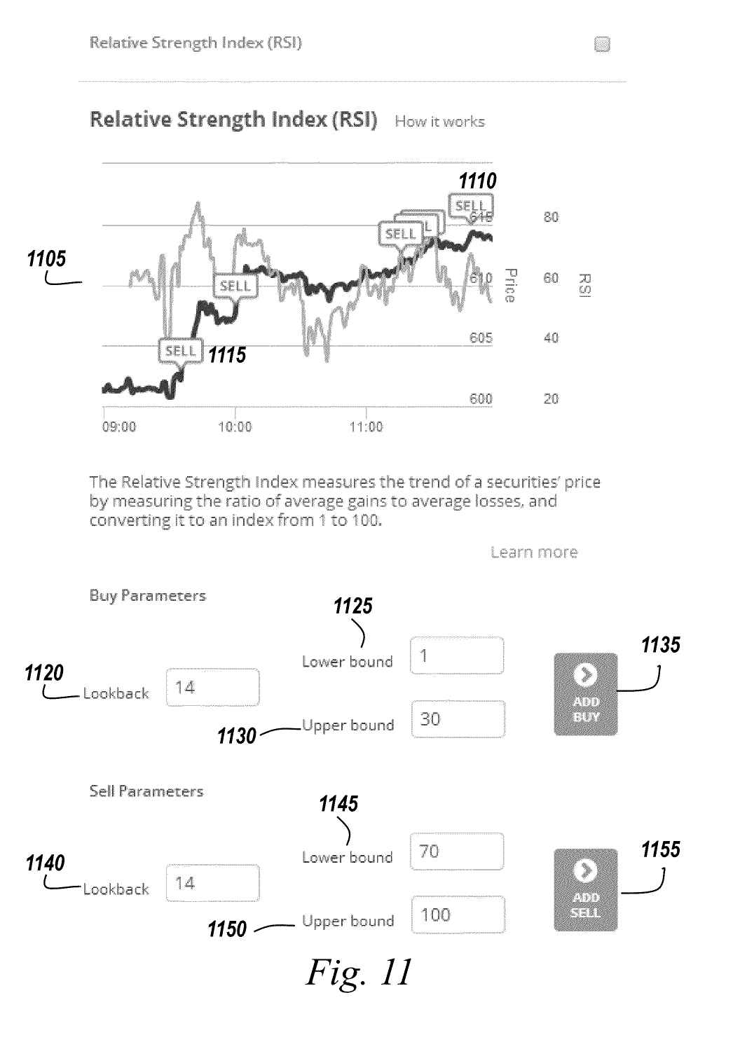

FIG. 11 illustrates a GUI for another indicator, Relative Strength Index (“RSI”), that can be included in the strategy. The RSI measures a trend of a securities' price by measuring a ratio of average gains to average losses, and converting the ratio to an index (e.g., from 1 to 100). The RSI GUI can include an illustrative chart 1105 that highlights buy or sell decisions 110 and 1115 made over a sample time period for a sample stock. The tool may receive RSI parameters for the strategy via input boxes. For example, for the RSI indicator, Buy and Sell parameters may include lookback 1120 and 1140, lower bound 1125 and 1145, and upper bound 1130 and 1150, respectively. The parameters may be input via an input text box, drop down menu, buttons, or other GUI widgets. The tool may receive an indication to add the RSI indicator for Buy or Sell decisions via input buttons 1135 and 1155.

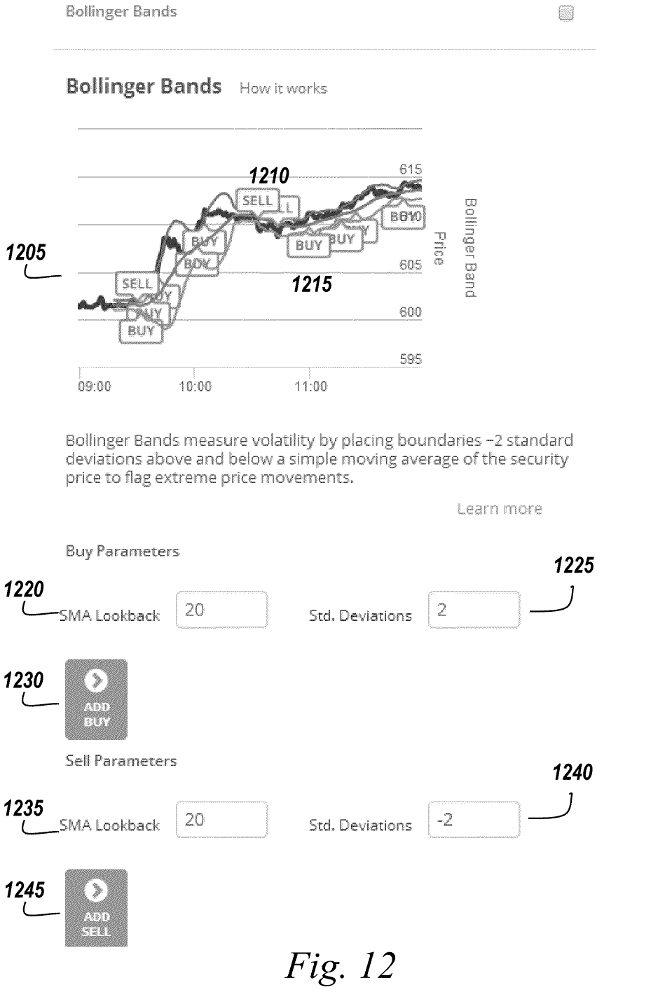

FIG. 12 illustrates a GUI for another indicator, Bollinger Bands, that can be included in the financial strategy. Bollinger bands can measure volatility by placing boundaries (e.g., ˜2 standard deviations) above and below a simple moving average of the security price to flag extreme price movements. To identify a Bollinger band, the tool can calculate or determine a stocks standard deviation (e.g., the amount of daily fluctuation that can be termed as normal in the stock's price). The Bollinger bands can then be placed at, e.g., values two times above and two below the stock's standard deviations, starting from the stock's rolling average price. The tool can derive signals when the stock fluctuates more than twice as far as would be expected in the normal course of events (e.g., two standard deviations). The buy and sell parameters for Bollinger bands can include SMA lookback 1220 and 1235, respectively, and standard deviations 1225 and 1240, respectively. The tool may receive an indication to add the Bollinger band indicator for Buy or Sell decisions via input buttons 1230 and 1245. The tool may provide an illustrative chart or graph 1205 of a Bollinger band indicator applied to a sample stock that indicates sell 120 and buy 1215 decisions over a sample time period.

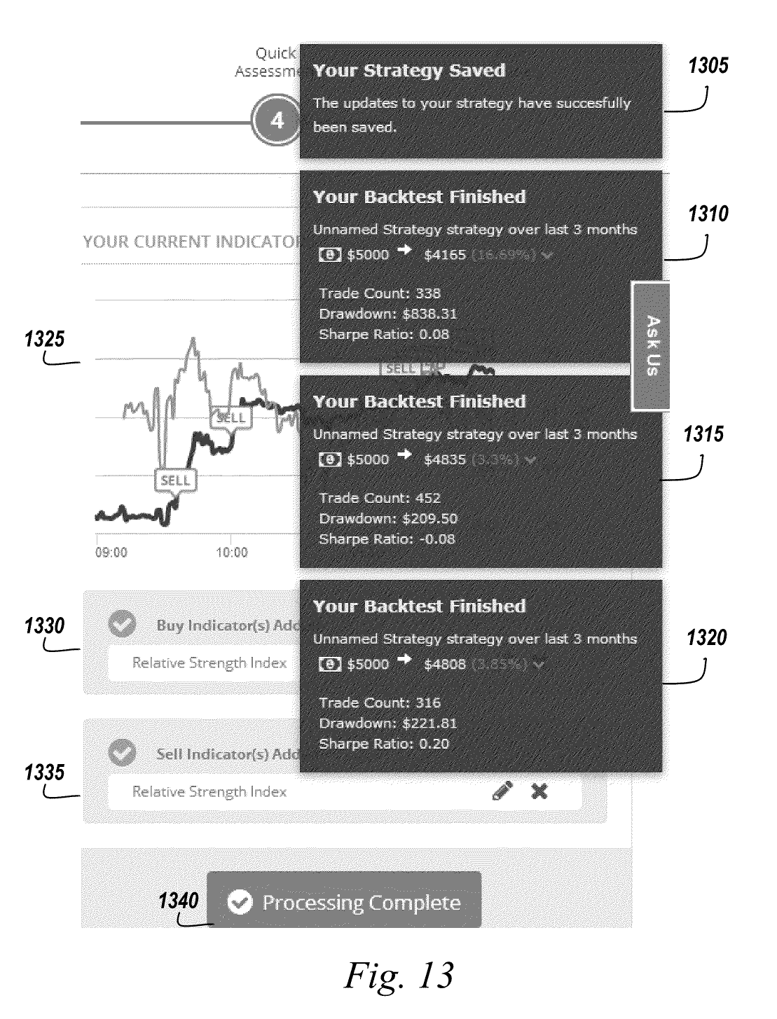

At step 725, the tool performs an initial assessment of the strategy in one or more markets 725. The tool can run the strategy, with the indicators, on multiple threads of a GPU, where each thread corresponds to a single company and includes applying one or more indicators of the strategy to the financial data for the company. As illustrated in FIG. 13, the tool may save the strategy 1305 and perform one or more back tests on various markets or time periods and indicate the results of same 1310-1320. The tool may provide a chart or graph 1325 illustrating the current indicators of the strategy as applied to financial data, the buy indicators 1330 and the sell indicators 1335. Back test information may include a name of the strategy, a time period for the back test data, the initial principle amount (e.g., $5000), the resulting amount (e.g., 4165), a percentage increase/decrease (e.g., −16.69%), the number of trades (e.g., trade count 338), the drawdown (e.g., $838.31), and the Sharpe ratio (e.g., 0.08, which can indicate an average return minus the risk-free return divided by the standard deviation of return on an investment). The GUI can illustrate when the processing is complete via dialogue box or button 1340, which may also be used to rerun the initial assessment.

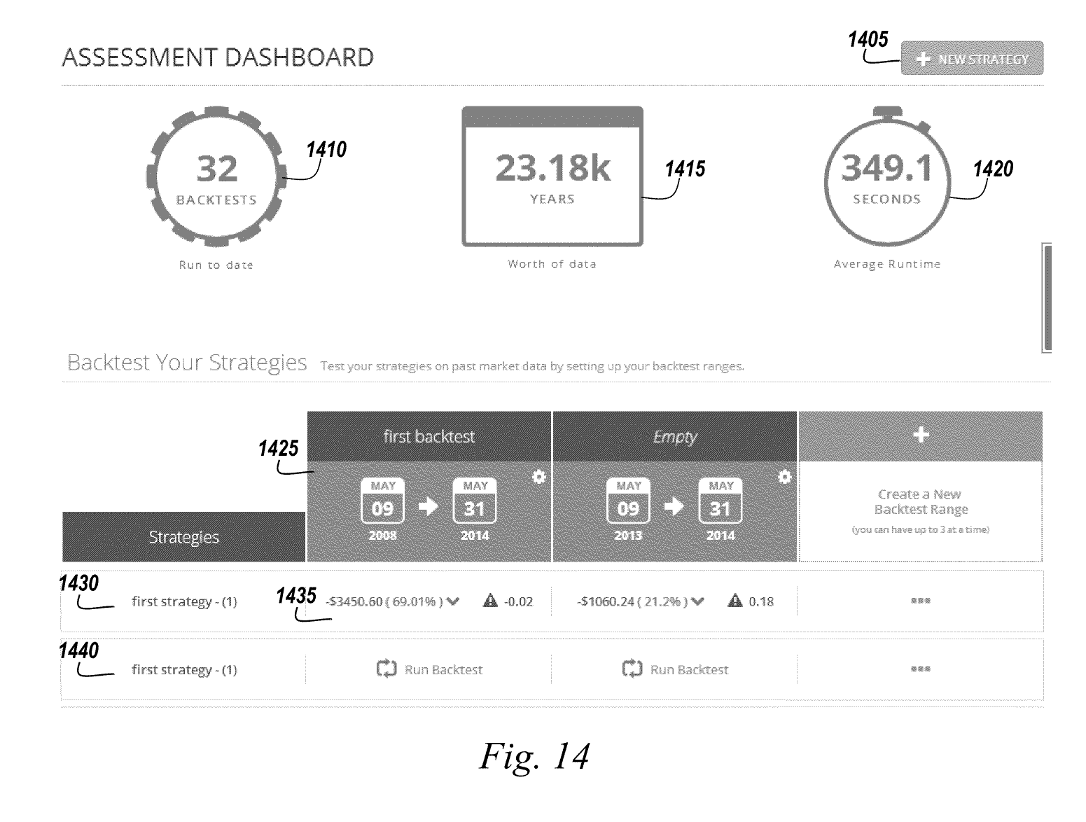

At step 730, the tool can back test the strategy in one or more markets. The back test may be run on additional data over a longer time period, multiple markets (e.g., current market, bull market, bear market). The back test may setup via a GUI, such as the GUI illustrated in FIG. 14. The back test may also be referred to as a full assessment of the strategy. The full assessment may include a GUI that provides an assessment dashboard, that includes a number of back tests run to date 1410 (e.g., 32 back tests), the number of years' worth of data 1415 (e.g., 23,180), and the average runtime for the full assessment 1420 (e.g., 349.1 seconds). A user may enter one or more strategies for the full assessment via input boxes 1430 and 1440, where each strategy is named and stored in a database. The tool can then back test each strategy over a certain time period 1425 (e.g., May 9, 2008 to May 31, 2014). The results 1435 of the back test can be displayed on the row corresponding to the strategy (e.g., −$3450.6 or −69.01% for the first strategy over the first back test time period; or −$1,060.24 or −21.2% for the first strategy over a second back test time period corresponding to May 9, 2013 to May 31, 2014).

In some embodiments, at step 735, the user may optimize or reassess a strategy by returning to a previous step (e.g., alter a preset 705, adjust filters 710, adjust indicators 720, re-assess strategy 725, and perform additional back tests 730 on new strategy. Thereafter, the tool may execute the strategy in real time at step 740. For example, the tool can obtain live real time data financial data feeds, calculate the selected indicators using multiple threads of a GPU, identify a financial decision such as a buy/sell decision, and provide a notification to a user of the buy/sell decision or automatically execute the trade via a financial exchange. For example, the tool can interface with a financial account of a user via the network, and provide an indication to execute the trade via the account. In some embodiments, the tool may have access to a financial account via a bank or other financial institution associate with a profile of the user.

In some embodiments, the tool can be configured to allow a user to add additional indicators in additional to the indicators initially provided by the tool. The tool can receive the formulas for the additional indicator or executable code for the additional integrator, integrate the indicator into the strategy, and run the indicator multiple threads of the GPU in a manner similar to the initial indicators.

While the invention has been particularly shown and described with reference to specific embodiments, it should be understood by those skilled in the art that various changes in form and detail may be made therein without departing from the spirit and scope of the invention described in this disclosure.

What is claimed is:

1. A method of parallel processing of financial exchange data, comprising:
receiving, by a data ingest module via an interface of a tool, data records for financial instruments from a data provider, wherein each of the data records includes a company identifier, a time stamp, a price, and a volume;
storing, by the data ingest module, the received data records in an indexed data structure;
identifying, by a computation engine of the tool, an indicator of a strategy set via a user interface of the tool;
applying, by the computation engine of the tool via a first thread of a processor of the tool, the indicator to a first portion of the indexed data structure corresponding to a first company to generate a first assessment;
applying, by the computation engine of the tool via a second thread of a processor of the tool, the indicator to a second portion of the indexed data structure corresponding to a second company to generate a second assessment, the first thread overlapping with the second thread; and
executing, by the computation engine, based on the first assessment and the second assessment, the strategy on a real-time feed of data records for financial instruments.

2. The method of claim 1, further comprising:
performing, by the data ingest module configured with middleware executing on the processor of the tool, meta value determinations on the data records;
indexing, by the data ingest module, the data records based on the determined meta value; and
storing, by the data ingest module, the indexed data records in the indexed data structure based on the determined meta value.

3. The method of claim 1, further comprising:
generating, by the tool, a query responsive to a filter set via the interface of the tool;
transmitting, by the tool via an HTTP fetch, the query to the data provider;
receiving, by the tool, a response to the transmitted query;
maintaining, by the data ingest module, a materialized view with the response in the indexed data structure.

4. The method of claim 1, further comprising:
maintaining, by the data ingest module, historical data and the real time feed of data in the indexed data structure using a same database scheme.

5. The method of claim 1, further comprising;
establishing, by the tool, a plurality of indicators of the strategy, the plurality of indicators of the strategy including at least two of a moving average cross, a relative strength index, and a Bollinger band;
applying, by the computation engine of the tool via the first thread of the processor of the tool, the plurality of indicators to the first portion of the indexed data structure corresponding to the first company to generate the first assessment; and
applying, by the computation engine of the tool via the second thread of the processor of the tool, the plurality of indicators to the second portion of the indexed data structure corresponding to the second company to generate the second assessment.

6. The method of claim 1, further comprising:
applying, by the computation engine, a moving average indicator to smooth data to form a trend pattern to predict or estimate a price direction for a first time interval; and
responsive to receiving real time feed data, removing a first value in the trend pattern and adding a second value to the trend pattern.

7. The method of claim 1, further comprising:
applying, by the computation engine via a plurality of threads of a graphical processing unit, the strategy on data records for a plurality of companies, wherein the computation engine applies the strategy for each of the plurality of companies on a separate thread of the plurality of threads.

8. The method of claim 1, further comprising:
applying, by the computation engine, the strategy to data records of an entire financial instrument exchange on a periodic basis, the periodic basis including at least one of daily or hourly.

9. The method of claim 1, further comprising:
using, by the computation engine, a message passing interface to apply the strategy for a plurality of companies in the indexed data structure.

10. The method of claim 1, further comprising:
receiving, by the tool, a filter via the interface of the tool; and
identifying, by the tool, a company mix based on the filter including the first company and the second company.

11. A system to parallel process financial exchange data, comprising:
a tool executed by a processor;
a data ingest module of the tool configured to receive, via an interface, data records for financial instruments from a data provider, wherein each of the data records includes a company identifier, a time stamp, a price, and a volume;
the data ingest module further configured to store the received data records in an indexed data structure;
a computation engine of the tool configured to:
identify an indicator of a strategy set via the interface of the tool;
apply, via a first thread of the processor, the indicator to a first portion of the indexed data structure corresponding to a first company to generate a first assessment;
apply, via a second thread of a processor of the tool, the indicator to a second portion of the indexed data structure corresponding to a second company to generate a second assessment, the first thread overlapping with the second thread; and
execute, based on the first assessment and the second assessment, the strategy on a real-time feed of data records for financial instruments.

12. The system of claim 11, wherein the tool is further configured to:
perform, with middleware executed by the processor, meta value determinations on the data records;
index the data records based on the determined meta value; and
store the indexed data records in the indexed data structure based on the determined meta value.

13. The system of claim 11, wherein the tool is further configured to:
generate a query responsive to a filter set via the interface of the tool;
transmit, via an HTTP fetch, the query to the data provider;
receive a response to the transmitted query;
maintain a materialized view with the response in the indexed data structure.

14. The system of claim 11, wherein the tool is further configured to:
maintain historical data and the real time feed of data in the indexed data structure using a same database scheme.

15. The system of claim 11, wherein the tool is further configured to;
establish a plurality of indicators of the strategy, the plurality of indicators of the strategy including at least two of a moving average cross, a relative strength index, and a Bollinger band;
apply, via the first thread of the processor of the tool, the plurality of indicators to the first portion of the indexed data structure corresponding to the first company to generate the first assessment; and
apply, via the second thread of the processor of the tool, the plurality of indicators to the second portion of the indexed data structure corresponding to the second company to generate the second assessment.

16. The system of claim 11, wherein the tool is further configured to:
apply a moving average indicator to smooth data to form a trend pattern to predict or estimate a price direction for a first time interval; and
responsive to reception of a real time feed data, remove a first value in the trend pattern and adding a second value to the trend pattern.

17. The system of claim 11, wherein the tool is further configured to:
apply, via a plurality of threads of a graphical processing unit, the strategy on data records for a plurality of companies, wherein the computation engine applies the strategy for each of the plurality of companies on a separate thread of the plurality of threads.

18. The system of claim 11, wherein the tool is further configured to:
apply the strategy to data records of an entire financial instrument exchange on a periodic basis, the periodic basis including at least one of daily or hourly.

19. The system of claim 11, wherein the tool is further configured to:
use a message passing interface to apply the strategy for a plurality of companies in the indexed data structure.

20. The system of claim 11, wherein the tool is further configured to:
receive a filter via the interface of the tool; and
identify a company mix based on the filter including the first company and the second company.
